(19) United States
(12) Patent Application Publication
(10) Pub. No.: US 2009/0130518 A1
(43) Pub. Date: May 21, 2009

(54) ELECTROCATALYST FOR FUEL CELL, METHOD OF PREPARING THE SAME AND FUEL CELL INCLUDING AN ELECTRODE HAVING THE ELECTROCATALYST

(75) Inventors: Kang-hee LEE, Yongin-si (KR); Kyung-jung Kwon, Yongin-si (KR); Duck-young Yoo, Yongin-si (KR); Victor Roev, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/141,518

(22) Filed: Jun. 18, 2008

(30) Foreign Application Priority Data
Nov. 20, 2007 (KR) 2007-118522

(51) Int. Cl. H01M 8/10; B01J 23/10; H01M 4/88

(52) U.S. Cl. 429/30; 502/304; 502/101

(57) ABSTRACT

An electrocatalyst for a fuel cell includes a Pt—Co-based first metal catalyst, a Ce-based second metal catalyst, and a carbon-based catalyst support. A method of preparing the electrocatalyst includes obtaining a mixture of metal oxides from a Pt precursor, a Co precursor, and a Ce precursor; impregnating the mixture of the metal oxides onto a carbon-based catalyst support under hydrogen bubbling; and thermally reducing the resulting product at 200 to 350° C. under a hydrogen atmosphere.

### CROSS-REFERENCE TO RELATED APPLICATIONS

This application claims the benefit of Korean Application No. 2007-118522, filed Nov. 20, 2007, in the Korean Intellectual Property Office, the disclosure of which is incorporated herein by reference.

### BACKGROUND OF THE INVENTION

1. Field of the Invention

Aspects of the present invention relate to an electrocatalyst for a fuel cell, a method of preparing the same, and a fuel cell including an electrode having the electrocatalyst. More particularly, aspects of the present invention relate to an electrocatalyst for a fuel cell with improved oxygen reduction reaction (ORR) and hydrogen oxidation reaction (HOR) efficiencies, a method of preparing the electrocatalyst, and a fuel cell including the electrocatalyst.

2. Description of the Related Art

Fuel cells obtain electromotive force by a cell reaction that generates water from hydrogen and oxygen. Hydrogen is obtained by reacting raw materials such as methanol and water under the presence of a reformed catalyst. Fuel cells can be categorized into a polymer electrolyte membrane (PEM) type, a phosphate type, a molten carbonate type, and a solid oxide type, depending on the types of electrolytes used. The operating temperatures and properties of the components of fuel cells vary depending on the electrolyte used.

A polymer electrolyte membrane fuel cell (PEMFC), which is a fuel cell using a polymer electrolyte membrane, is conventionally formed of an anode, a cathode, and a membrane-electrode assembly (MEA) including a polymer electrolyte membrane disposed between the anode and the cathode. The anode of a PEMFC includes a catalyst layer to facilitate oxidation of a fuel, and the cathode of a PEMFC includes a catalyst layer to facilitate the reduction of an oxidant.

A catalyst having platinum (Pt) as the active element is typically used as a component of the anode and the cathode, and the activity of the catalyst has a great influence on the electrode performance. Therefore, as shown in Korean Patent Laid-open Publication No. 2000-0063843, research is being actively conducted to develop a fuel cell with high performance by enhancing the activity of platinum supported catalysts.

### SUMMARY OF THE INVENTION

Aspects of the present invention provide an electrocatalyst for a fuel cell with increased catalytic activity provided by the presence of a cerium oxide, a method of preparing the electrocatalyst, and a fuel cell including an electrode having the electrocatalyst.

According to an aspect of the present invention, there is provided an electrocatalyst for a fuel cell comprising a carbon-based catalyst support; and a ternary metal catalyst comprising Pt, Co and Ce supported on the catalyst support.

According to another aspect of the present invention, the electrocatalyst may include 10 to 60 parts by weight of Pt, 1 to 20 parts by weight of Co, and 0.1 to 30 parts by weight of Ce based on 100 parts by weight of the sum of the catalyst support and the metal catalyst.

According to another aspect of the present invention, the ternary metal catalyst may include a Pt—Co based first metal catalyst and a Ce-based second metal catalyst.

According to another aspect of the present invention, the first metal catalyst and the second metal catalyst may be located adjacent to each other on the carbon based catalyst support.

According to another aspect of the present invention, the first metal catalyst may include a Pt—Co alloy or a Pt—Co—Ce alloy.

According to another aspect of the present invention, the second metal catalyst may include CeO₂ and Ce₂O₃.

According to another aspect of the present invention, the second metal catalyst may include particles having a core including CeO₂ and a shell including Ce₂O₃.

According to another aspect of the present invention, the carbon-based catalyst support may be one of Ketchen black, carbon black, graphite carbon, carbon nanotube, and carbon fiber.

According to another aspect of the present invention, there is provided a method of preparing an electrocatalyst for a fuel cell including obtaining a metal oxide by oxidizing a Pt precursor, a Co precursor, and a Ce precursor; impregnating a carbon-based catalyst support in a mixture including the metal oxides under a hydrogen bubbling condition; and thermally reducing the resulting product at 200 to 350° C. under a hydrogen atmosphere.

According to another aspect of the present invention, there is provided a fuel cell including an electrode including the electrocatalyst for fuel cells previously described and an electrolyte membrane.

According to another aspect of the present invention, the electrode may be a cathode.

According to another aspect of the present invention, there is provided a fuel cell comprising an anode; a cathode; and an electrolyte membrane between the anode and the cathode, wherein at least one of the anode and the cathode comprises the electrocatalyst previously described.

According to another embodiment of the present invention, there is provided an electrocatalyst of a fuel cell comprising oxides of platinum, cobalt and cerium on a solid support.

According to another embodiment of the present invention, there is provided an electrocatalyst of a fuel cell, comprising a solid support; a first metal catalyst on the solid support comprising an alloy of Pt and Co or an alloy of Pt, Co and Ce; and a second metal catalyst on the solid support comprising one or more oxides of Ce.

According to another embodiment of the present invention, there is provided an electrocatalyst formed by the method comprising obtaining a mixture of metal oxides from a Pt precursor, a Co precursor, and a Ce precursor; impregnating the mixture of the metal oxides onto a carbon-based catalyst support under hydrogen bubbling; and heat-treating the resulting product at 200 to 350° C. under a hydrogen atmosphere to provide a ternary metal catalyst comprising Pt, Co and Ce supported on the catalyst support.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram schematically illustrating an electrocatalyst for a fuel cell according to an embodiment of the present invention;

FIG. 2 is a schematic flow chart of a method of preparing the electrocatalyst for a fuel cell according to an embodiment of the present invention;

FIG. 3 is a transmission electron microscopic (TEM) image of the electrocatalyst of Example 1;

FIG. 4 is a spectrum obtained by X-ray photoemission spectroscopy (XPS) of the electrocatalyst of Example 1;

FIG. 5 is a graph illustrating the oxygen reduction reaction (ORR) activity of an electrode including the catalyst of Example 1, an electrode including the catalyst of Comparative Example 1 and an electrode including the catalyst of Comparative Example 2;

FIG. 6 is a graph illustrating the hydrogen oxidation reaction (HOR) activity of a an electrode including the catalyst of Example 1 and an electrode including the catalyst of Comparative Example 1;

FIG. 7 is a graph comparing a potential change according to the current density with respect to an electrode including the catalyst of Example 1 and an electrode including the catalyst of Comparative Example 1;

FIG. 8 is an exploded perspective view of a fuel cell according to an embodiment of the present invention; and

FIG. 9 is a cross-sectional diagram of a membrane-electrode assembly included in the fuel cell of FIG. 8.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Aspects of the present invention provide an electrocatalyst for a fuel cell including a carbon-based catalyst support and a ternary metal catalyst of Pt—Co—Ce supported on the catalyst support.

Conventional fuel cells include a solid polymer membrane disposed between an anode having a platinum catalytic layer and a cathode also having a platinum catalytic layer. In the anode, the following reaction takes place in the platinum catalytic layer of the anode.

H₂→2H⁺+2e⁻

H⁺ produced from the reaction diffuses into an electrolyte. Meanwhile, in the cathode, the following reaction takes place in the platinum catalytic layer of the cathode.

2H⁺+2e⁻+½O₂→H₂O

The electrocatalyst according to an embodiment of the present invention uses a Pt—Co or Pt—Co—Ce alloy as a first metal catalyst instead of the conventional Pt catalyst, thereby providing a PEMFC or a PAFC with superior electrocatalyst activity for fuel cells. Moreover, the electrocatalyst according to an embodiment of the present invention also uses a second metal catalyst derived from cerium oxide having superior oxygen activity or transferability, providing an electrocatalyst for fuel cells having superior activity, even at operating temperatures under 200° C.

As a non-limiting example, the electrocatalyst for a fuel cell according to an embodiment of the present invention may include 10 to 60 parts by weight of Pt, 1 to 20 parts by weight of Co, and 0.1 to 30 parts by weight of Ce, based on 100 parts by weight of the sum of the catalyst support and the metal catalyst, in view of the electrochemical surface area of the catalyst and oxygen reduction reaction (ORR) and (hydrogen oxidation reaction) HOR.

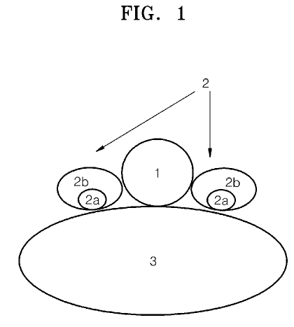

FIG. 1 is a diagram schematically illustrating an electrocatalyst for a fuel cell according to an embodiment of the present invention. A Pt—Co-based first metal catalyst 1 and a Ce-based second metal catalyst 2 are supported by a carbon-based catalyst support 3. As a non-limiting example, the first metal catalyst 1 and the second metal catalyst 2 may be disposed adjacent to each other. Without being bound to any particular theory, it is believed that the Ce-based second metal catalyst 2 has a superior ability to transfer oxygen to the adjacent first metal catalyst 1 and to facilitate oxidation reduction reactions of the electrocatalyst. With respect to the activity of the cell, the first metal catalyst 1 may be an alloy of Pt—Co or an alloy of Pt—Co—Ce. As shown in FIG. 1, the second metal catalyst 2, may include a core 2a of CeO₂ and a shell 2b of Ce₂O₃, which has higher activity in oxidation and reduction reactions.

As non-limiting examples, the carbon-based catalyst support may be one of Ketchen black, carbon black, graphite carbon, carbon nanotube, and carbon fiber, each having high electric conductivity and large surface area.

The electrocatalyst for a fuel cell according to aspects of the present invention may be prepared using a colloidal method.

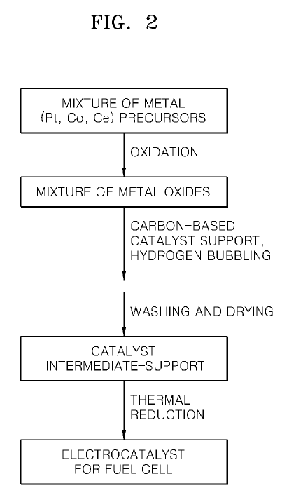

FIG. 2 is a schematic flow chart of a method of preparing the electrocatalyst for a fuel cell according to an embodiment of the present invention. First, a solution of a platinum (Pt) precursor dissolved in water is mixed with an oxidant such as hydrogen peroxide (H₂O₂) to form platinum oxide. A cobalt (Co) precursor and a cerium (Ce) precursor are added sequentially to the resulting product and reacted with the remaining oxidant within the solution to form cobalt oxide and cerium oxide.

As a platinum precursor, chloroplatinous acid (H₂PtCl₄), chloroplatinic acid (H₂PtCl₆), potassium tetrachloroplatinate (K₂PtCl₄), potassium hexachloroplatinate (K₂PtCl₆), diaminedinitroplatinum (Pt(NO₂)₂(NH₃)₂), or dihydrogen hexahydroxyplatinum (H₂Pt(OH)₆) may be used. As a cerium precursor, cerium (III) acetate, cerium (III) bromide, cerium (III) carbonate, cerium (III) chloride, cerium (IV) hydroxide, cerium (III) nitrate, cerium (III) sulfate, or cerium (IV) sulfate may be used. As a cobalt precursor, cobalt (II) chloride (COCl₂), cobalt (II) sulfate (COSO₄), or cobalt (II) nitrate (Co(NO₃)₂) may be used.

Under hydrogen bubbling, the carbon-based catalyst support is impregnated into the resulting colloid solution, then, drying is performed to obtain a solid-state intermediate. The resulting product is then washed with water several times, dried, and then thermally reduced to obtain the electrocatalyst. Thermal reduction may be performed under a hydrogen atmosphere at 200 to 350° C. for 0.5 to 4 hours. The thermal reduction provides an electrocatalyst having a superior activity and a significantly increased oxido-reduction current within the range of 0.6 to 0.8V, which is the voltage range typically used by an electrode.

In addition, aspects of the present invention provide a fuel cell including the electrocatalyst described above. The fuel cell according to an embodiment of the present invention includes a cathode, an anode, and an electrolyte membrane disposed between the cathode and the anode, wherein at least one of the cathode and anode contains the electrocatalyst as described above. As a non-limiting example, the supported catalyst according to the present invention may be applied to the cathode. As non-limiting examples, the fuel cell may be a phosphoric acid fuel cell (PAFC), a polymer electrolyte membrane fuel cell (PEMFC), or a direct methanol fuel cell (DMFC). As a specific, non-limiting example, the fuel cell may be a PEMFC.

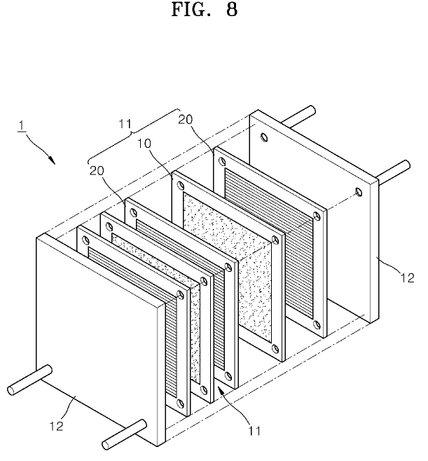

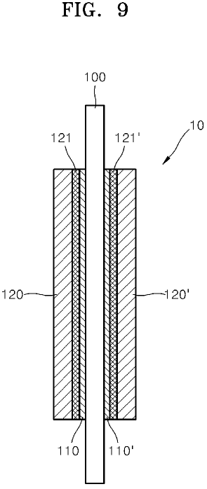

FIG. 8 is a perspective exploded view of a fuel cell according to an embodiment of the present invention, and FIG. 9 is a cross-sectional diagram of a membrane-electrode assembly (MEA) that forms the fuel cell of FIG. 8.

The fuel cell 1 shown schematically in FIG. 8 is formed of two unit cells 11 sandwiched between a pair of holders 12. Each unit cell 11 is composed of an MEA 10, and bipolar plates 20 disposed on lateral sides of the MEA 10. The bipolar plates 20 comprise a conductive metal, carbon or the like, and function as current collectors, while providing oxygen and fuel to the catalytic layers of the MEA s10.

Although only two unit cells 11 are shown in FIG. 8, it is to be understood that the number of unit cells is not limited to two and that a fuel cell may have several tens or hundreds of unit cells, depending on the required properties of the fuel cell.

As shown in FIG. 9, each MEA 10 is formed of an electrolyte membrane 100, catalytic layers 110 and 110′ disposed on lateral sides of the electrolyte membrane 100, and first gas diffusion layers 121 and 121′ respectively stacked on the catalytic layers 110 and 110′, and second gas diffusion layers 120 and 120′ respectively stacked on the first gas diffusion layers 121 and 121′.

The catalytic layers 110 and 110′ function as a fuel electrode and an oxygen electrode each including a catalyst and a binder therein, and may further include a material that can increase the electrochemical surface area of the catalyst. At least one of the catalytic layers comprises an electrocatalyst according to aspects of the present invention.

The first gas diffusion layers 121 and 121′ and the second gas diffusion layers 120 and 120′ may each be formed of a material such as, for example, carbon sheet or carbon paper, The first gas diffusion layers 121 and 121′ and the second gas diffusion layers 120 diffuse oxygen and fuel supplied through the bipolar plates 20 to the entire surface of the catalytic layers 110 and 110′.

The fuel cell 1 including such an MEA 10 typically operates at a temperature of 100 to 300° C. Fuel such as hydrogen is supplied through one of the bipolar plates 20 into a first catalytic layer, and an oxidant such as oxygen is supplied through the other bipolar plate 20 into a second catalytic layer. Then, hydrogen is oxidized in the first catalytic layer producing protons, and conducts the proton to the second catalytic layer, and the conducted protons and oxygen electrochemically react to produce water in the second catalytic layer, and to produce electrical energy. Moreover, hydrogen supplied as a fuel may be hydrogen produced by reforming hydrocarbons or alcohols, and oxygen supplied as an oxidant may be supplied in the form of air. It is to be understood that the structure and operation of the membrane electrode assembly is not limited to what is described herein, and that other structures and modes of operation may be used.

Aspects of the present invention will now be described in detail with reference to the following examples. However the examples are not intended to limit the scope of the present invention.

### EXAMPLES

### Example 1

### Preparation of a Pt—Co—Ce Ternary Electrocatalyst

5 g of NaHSO₃ was added to 200 g of a 1 M solution of hydrated chloroplatinic acid (H₂PtCl₆.xH₂O), as a platinum precursor dissolved in water, and stirred thoroughly to produce a solution of H₂Pt(SO₃)₂Cl₆.OH. 50 ml of hydrogen peroxide was added to the resulting solution to produce PtO₂. Then, 0.5 g of CoCl₂.6H₂O as a cobalt precursor and 0.5 g of (NH₄)₂Ce(NO₃)₆ as a cerium precursor were added and reacted with the hydrogen peroxide remaining in the solution, thereby producing cobalt oxide (CoO) and cerium oxide (CeO₂).

To the resulting colloid solution, 0.5 g of Ketchen black was added as a carbon catalytic support while bubbling in hydrogen, and stirring was further performed for 12 hours. The resulting solid was washed several times with water, and then was dried under nitrogen atmosphere at 120° C.

Then, the resulting solid product was thermally reduced at 280° C. in hydrogen gas to produce an electrocatalyst.

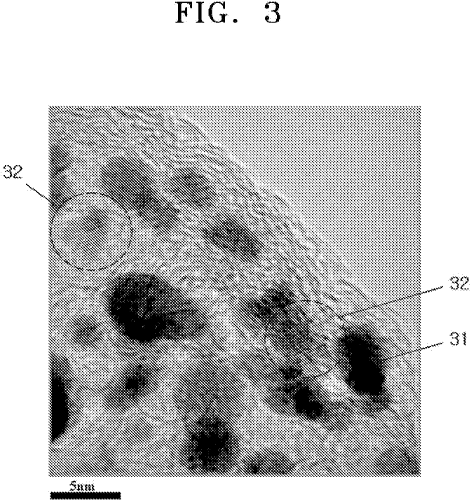

The surface of the final electrocatalyst product was analyzed with a transmission electron microscope (TEM) and the results are shown in FIG. 3. Referring to FIG. 3, cerium oxide regions 32 with a size of about 4 nm exist close to Pt—Co alloy regions 31 having a size of about 2-5 nm. By analyzing the spacings of the cerium oxide, (004) and (112) planes of CeO₂ were observed. From the spacings of the crystals, it can be determined that inner portions of the cerium oxide regions 32 exist in the form of CeO₂ with Ce having an oxidation number of +4.

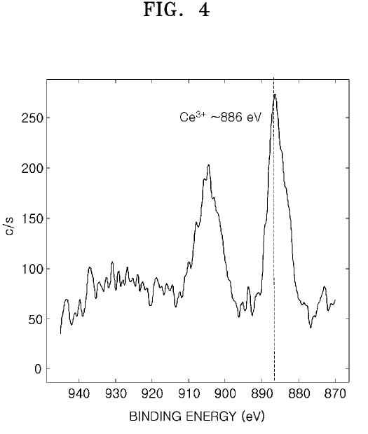

The final product prepared above was analyzed with X-ray Photoemission Spectroscopy (XPS) and the result is shown in FIG. 4. The oxidation number of Ce existing on a surface was analyzed by XPS, and it was found that the Ce³⁺ form was dominant. From the results of TEM and XPS, it can be determined that the cerium oxide exists in the form of CeO₂ crystals surrounded by CeO₃ crystals. That is, the electrocatalyst according to an embodiment of the present invention has a second metal catalyst with a core portion of CeO₂ and a shell portion of CeO₃.

### COMPARATIVE EXAMPLE 1

### Preparation of Pt—Co Electrocatalyst (Not Containing Ce)

5 g of NaHSO₃ was added to 200 g of 1 M solution of hydrated chloroplatinic acid (H₂PtCl₆.xH₂O), as a platinum precursor dissolved in water, and stirred thoroughly to produce a solution of H₂Pt(SO₃)₂Cl₆.OH. 50 ml of hydrogen peroxide was added to the resulting solution to produce PtO₂. Then, 0.5 g of CoCl₂.6H₂O as a cobalt precursor was added and reacted with the hydrogen peroxide remaining in the solution, thereby producing cobalt oxide (CoO).

To the resulting slurry solution, 0.5 g of Ketchen black was added as a carbon catalytic support while bubbling in hydrogen, and stirring was further performed for 12 hours. The resulting solid was washed several times with water, and dried at 120° C. under nitrogen atmosphere.

The resulting solid product was thermally reduced at 280° C. in hydrogen gas to produce an electrocatalyst.

Comparative Example 2

### Electrocatalyst without Thermal Reduction

5 g of NaHSO₃ was added to 200 g of 1 M solution of hydrated chloroplatinic acid (H₂PtCl₆.xH₂O), as a platinum precursor dissolved in water, and stirred thoroughly to produce a solution of H₂Pt(SO₃)₂Cl₆.OH. 50 ml of hydrogen peroxide was added to the resulting solution to produce PtO₂. Then, 0.5 g of CoCl₂.6H₂O as a cobalt precursor was added and reacted with the hydrogen peroxide remaining in the solution, thereby producing cobalt oxide (CoO).

To the resulting slurry solution, 0.5 g of Ketchen black was added as a carbon catalytic support while bubbling in hydrogen, and stirring was further performed for 12 hours. The resulting solid was washed several times with water, and dried at 120° C. under nitrogen atmosphere.

### Example 2

### Preparation of Electrode and Evaluation of ORR Activity

### (1) Preparation of Electrode

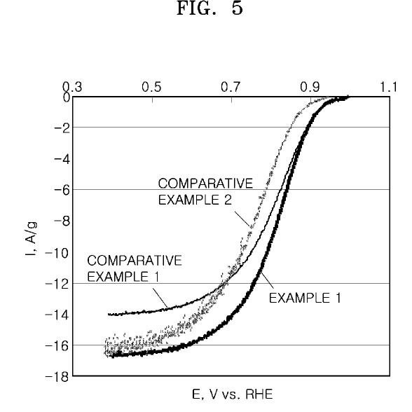

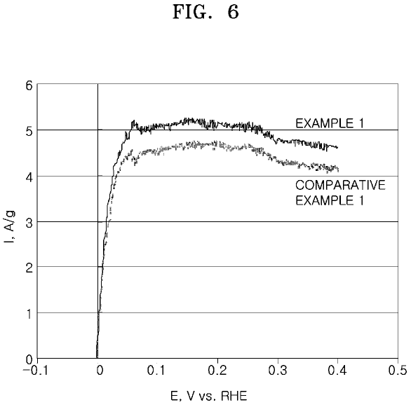

For each 1 g of the catalyst synthesized in Example 1, 0.1 g of polyvinylidene fluoride (PVDF) and an adequate amount of solvent (n-methylpyrrolidone (NMP)) were mixed to produce a rotating disk electrode (RDE) forming slurry. The slurry was loaded onto a glassy carbon film used as a substrate of the RDE, then a drying process was performed in which the temperature was increased incrementally from room temperature to 150° C. to produce the RDE. Using the produced RDE as a working electrode, the quality of the catalyst was evaluated as described below, with the results shown in FIGS. 5 and 6.

Electrodes were produced using the same method except that the catalysts prepared from Comparative Examples 1 and 2 were used, and the results of quality evaluations of the catalysts according to the comparative examples are also shown in FIGS. 5 and 6.

### (2) Evaluation of ORR Activity

The oxygen reduction reaction (ORR) activity was evaluated by dissolving oxygen in an electrolyte to saturation, and then scanning the potential in a negative direction of the open circuit voltage (OCV) while recording the corresponding currents (scan rate: 1 mV/s, electrode rotation speed: 1000 rpm). In the I-V (current-voltage) profile below an operating potential (0.6-0.8V) where oxygen reduction reaction of an electrode mainly takes place, material limiting current is reached at a lower potential. A material limiting current is a maximum current upon depletion of reagents, and in the RDE experiment, upon increase of the rotation speed of the electrode, the supply of oxygen dissolved in the electrolyte to the surface of the electrode was increased, thereby increasing the material limiting current, as well as the current in the entire potential region.

Using the electrode prepared by the method detailed above, ORR activities of the catalysts from Example 1 and Comparative Examples 1 and 2 were compared, with the results shown in FIG. 5. Referring to FIG. 5, the catalyst of Example 1 underwent an optimized thermal reduction, thereby maintaining the advantages of the material limiting current increase, and had an OCV having an increased ORR current in all potential regions compared to the catalyst of Comparative Example 1 without Ce and the catalyst of Comparative Example 2 without Ce and without thermal reduction.

### (3) Evaluation of HOR

The hydrogen oxidation reaction (HOR) activity was evaluated by first dissolving hydrogen in an electrolyte to saturation, and then scanning the potential in a positive direction of the OCV while recording the corresponding currents (scan rate: 1 mV/s, electrode rotation speed: 400 rpm)

Using the electrode prepared by the method detailed above, HOR activities of the catalysts were compared and shown in FIG. 6. Referring to FIG. 6, it can be seen that the HOR current flow of the catalyst from Example 1 is greater than that of the catalyst of Comparative Example 1, verifying that the catalyst according to aspects of the present invention has a superior effect as a catalyst for an anode.

### Example 3

### Preparation and Evaluation of Fuel Cell

For each 1 g of the catalyst synthesized in Example 1, 0.03 g of polyvinylidene fluoride (PVDF) and an adequate amount of solvent (NMP) were mixed to produce a cathode-forming slurry. The cathode-forming slurry was coated with a bar coater on a carbon paper coated with microporous layer. The coated slurry was then subjected to a drying process involving increasing the temperature incrementally from room temperature to 150° C. to produce a cathode.

Separately, an anode was prepared using the same method as above except that a carbon-supported Pt—Co catalyst (Tanaka Jewelry, Pt: 30 wt %, Ru: 23 wt %) was used instead of the catalyst synthesized in Example 1.

A membrane-electrode assembly (MEA) was prepared using poly(2,5-benzimidazole) doped with 85% phosphoric acid as an electrolyte membrane between the cathode and the anode.

Additionally, an MEA was prepared using the catalyst prepared in Comparative Example 1 instead of the catalyst prepared in Example 1.

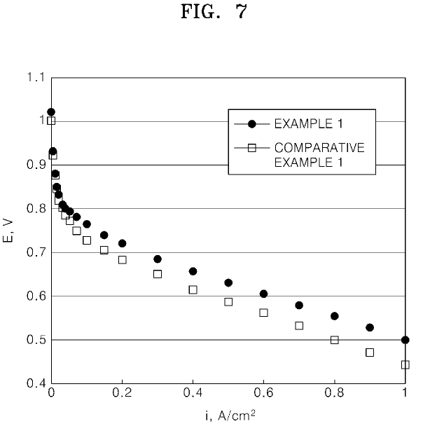

Then, the MEA properties of the MEA including the catalyst of Example 1 and the MEA including the catalyst of Comparative Example 1 were evaluated at 150° C. using desiccated air for the cathode and desiccated hydrogen for the anode. The results are shown in FIG. 7.

Referring to FIG. 7, the catalyst for fuel cells according to Example 1 produces an effect of increased voltage across almost the entire operating current region.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An electrocatalyst of a fuel cell, comprising:
a carbon-based catalyst support; and
a ternary metal catalyst comprising Pt, Co and Ce supported on the catalyst support.

2. The electrocatalyst of claim 1, comprising 10 to 60 parts by weight of Pt, 1 to 20 parts by weight of Co, and 0.1 to 30 parts by weight of Ce based on 100 parts by weight of the sum of the catalyst support and the metal catalyst.

3. The electrocatalyst of claim 1, wherein the ternary metal catalyst comprises a Pt—Co based first metal catalyst and a Ce-based second metal catalyst.

4. The electrocatalyst of claim 3, wherein the first metal catalyst is a Pt—Co alloy or a Pt—Co—Ce alloy.

5. The electrocatalyst of claim 3, wherein the second metal catalyst comprises CeO₂ and Ce₂O₃.

6. The electrocatalyst of claim 3, wherein the second metal catalyst comprises particles having a core comprising CeO₂ and a shell comprising Ce₂O₃.

7. The electrocatalyst of claim 3, wherein the first metal catalyst and the second metal catalyst are located adjacent to each other on the carbon based catalyst support.

8. The electrocatalyst of claim 1, wherein the carbon-based catalyst support is selected from the group consisting of Ketchen black, carbon black, graphite carbon, carbon nanotube, and carbon fiber.

9. An electrocatalyst of a fuel cell, comprising:
a solid support; and
a first metal catalyst on the solid support comprising an alloy of Pt and Co or an alloy of Pt, Co and Ce; and
a second metal catalyst on the solid support comprising one or more oxides of Ce.

10. The electrocatalyst of claim 9, wherein the second metal catalyst comprises particles having a core comprising CeO₂ and a shell comprising Ce₂O₃.

11. A method of preparing an electrocatalyst for a fuel cell, comprising:
obtaining a mixture of metal oxides from a Pt precursor, a Co precursor, and a Ce precursor;
impregnating the mixture of the metal oxides onto a carbon-based catalyst support under hydrogen bubbling; and
heat-treating the resulting product at 200 to 350° C. under a hydrogen atmosphere.

12. The method of claim 11, wherein the Pt precursor is selected from the group consisting of H₂PtCl₄, H₂PtCl₆, K₂PtCl₄, K₂PtCl₆, Pt(NO₂)₂(NH₃)₂, and H₂Pt(OH)₆.

13. The method of claim 11, wherein the Co precursor is selected from the group consisting of CoCl₂, CoSO₄, and Co(NO₃)₂.

14. The method of claim 11, wherein the Ce precursor is selected from the group consisting of cerium (III) acetate, cerium (III) bromide, cerium (III) carbonate, cerium (III) chloride, cerium (IV) hydroxide, cerium (III) nitrate, cerium (III) sulfate, and cerium (IV) sulfate.

15. The method of claim 11, wherein the oxidant is hydrogen peroxide.

16. The method of claim 11, wherein the carbon-based catalyst support is selected from the group consisting of Ketchen black, carbon black, graphite carbon, carbon nanotube, and carbon fiber.

17. An electrocatalyst formed by a method comprising:
obtaining a mixture of metal oxides from a Pt precursor, a Co precursor, and a Ce precursor;
impregnating the mixture of the metal oxides onto a carbon-based catalyst support under hydrogen bubbling; and
heat-treating the resulting product at 200 to 350° C. under a hydrogen atmosphere to provide a ternary metal catalyst comprising Pt, Co and Ce supported on the catalyst support.

18. A fuel cell comprising:
an electrode comprising an electrocatalyst according to claim 1; and
an electrolyte membrane.

19. The fuel cell of claim 18, wherein the electrode is a cathode.

20. The fuel cell of claim 18, wherein the fuel cell is a polymer electrolyte membrane fuel cell.

21. A fuel cell comprising:
an electrode comprising an electrocatalyst according to claim 9; and
an electrolyte membrane.
